(19) United States
(12) Patent Application Publication
(10) Pub. No.: US 2019/0366314 A1
(43) Pub. Date: Dec. 5, 2019

(54) RESIN WITH PROMOTER AND ANTIOXIDANT

(71) Applicants: DOW GLOBAL TECHNOLOGIES LLC, MIDLAND, MI (US); ROHM AND HAAS COMPANY, Philadelphia, PA (US)

(72) Inventors: Chunxia COSTEUX, Midland, MI (US); Chengli ZU, Midland, MI (US); Liu YANG, Shanghai (CN); Alfred K. SCHULTZ, Collegeville, PA (US)

(21) Appl. No.: 16/461,572

(22) PCT Filed: Dec. 30, 2016
(86) PCT No.: PCT/CN2016/113515

§ 371 Date: May 16, 2019

(51) Int. Cl. B01J 31/10; B01J 31/02; C08L 25/18; C08K 5/37

(52) U.S. Cl. CPC B01J 31/10; B01J 31/0217; C08K 5/37; C08L 25/18; B01J 31/0237

(57) ABSTRACT

Provided is a catalyst composition comprising
(a) a collection of resin beads having sulfonic acid functional groups,
(b) a promoter having a thiol group and an amine group, and
(c) an antioxidant having the structure (I)

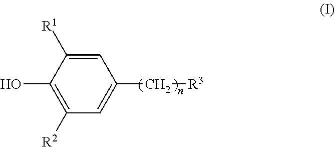

wherein each of R¹ and R², and R³ is hydrogen or a substituted or unsubstituted alkyl or alkenyl group
wherein n is 0 to 10, with the proviso that when R³ contains one or more nitrogen atoms, n is not 1 or 2.

Resin beads that have sulfonic acid groups are useful for a variety of purposes. For example, such resin beads are used as catalysts for useful chemical reactions such as the condensation of phenol with acetone to produce bisphenol-A. When resin beads are used as catalysts, it is sometimes useful to mix the resin beads with one or more promoter, which may not be chemically bound to the resin beads. The presence of the promoter improves the action of the catalyst in some way, for example by improving the selectivity of the reaction that is conducted in the presence of the catalyst. It is also desirable to store resin beads prior to using them as catalysts, and it is desired that little or no degradation of the resin beads takes place during the storage. One method that has been used to prevent degradation of the resin beads during storage is to mix the resin beads with one or more antioxidant, which may or may not be chemically bound to the resin beads.

U.S. Pat. No. 8,907,138 describes use of an antioxidant treated promoted strong acid ion exchange resin as an acid catalyst. The acid catalyst described in U.S. Pat. No. 8,907,138 was not subjected to long-term storage or to elevated temperature during storage.

In the course of developing the present invention, it has been discovered that cysteamine, a frequently-used thiol-amine promoter, reacts chemically with a frequently-used antioxidant. Sometime, cysteamine is added directly to a collection of resin beads, and sometimes 2,2-dimethylthiazolidine (“DMT”) is added to a collection resin beads, because it is considered that DMT can (for example, when water is present) undergo a chemical reaction to produce cysteamine. It has been discovered that, when cysteamine and that antioxidant are both present in a collection of resin beads, a chemical reaction takes place that destroys some or all of the antioxidant, thus leaving the resin beads vulnerable to degradation, especially during long-term and/or heated storage. It is desired to provide an antioxidant that does not react with thiol-amine promoter during long-term and/or heated storage.

The following is a statement of the invention.

A first aspect of the present invention is a catalyst composition comprising

(a) a collection of resin beads having sulfonic acid functional groups,

(b) a promoter having a thiol group and an amine group, and

(c) an antioxidant having the structure (I)

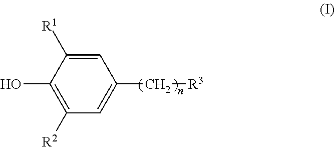

wherein each of R¹ and R², and R³ is hydrogen or a substituted or unsubstituted alkyl or alkenyl group, and wherein n is 0 to 20, with the proviso that when R³ contains one or more nitrogen atoms, n is not 1 or 2.

The following is a brief description of the drawings.

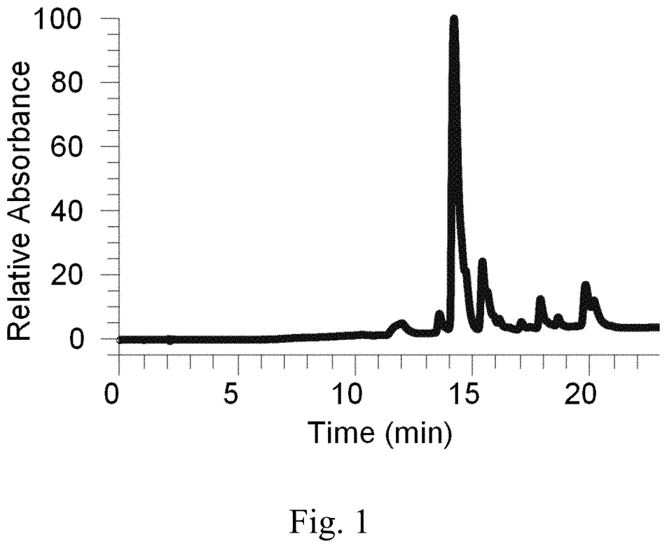

FIGS. 1-6 show the results of LC/UV/MS analysis of solutions, with the solutes as follows.

FIG. 1 was ETHANOX™ 703.

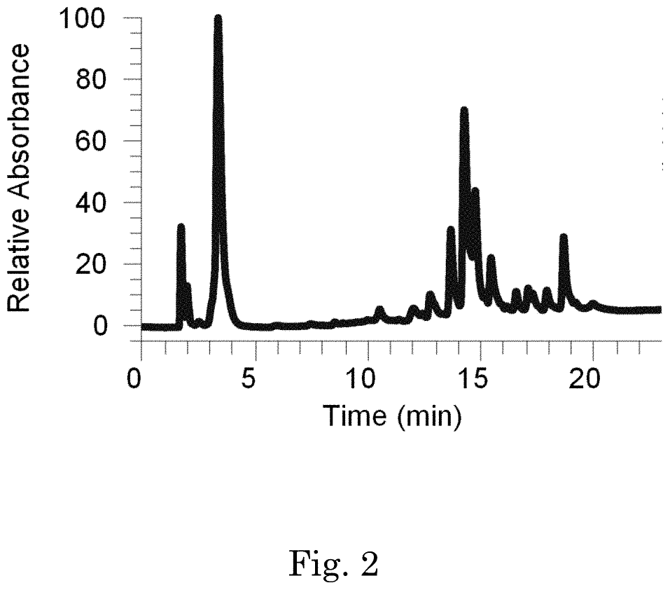

FIG. 2 was ETHANOX™ 703 and DMT.

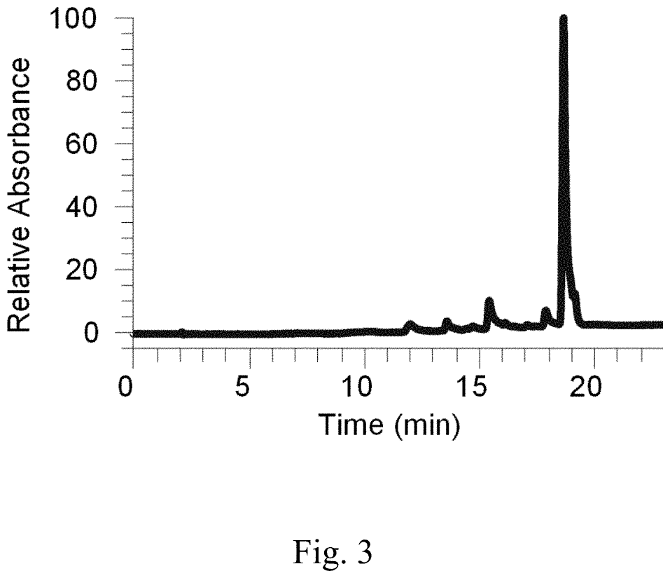

FIG. 3 was DtBP, and

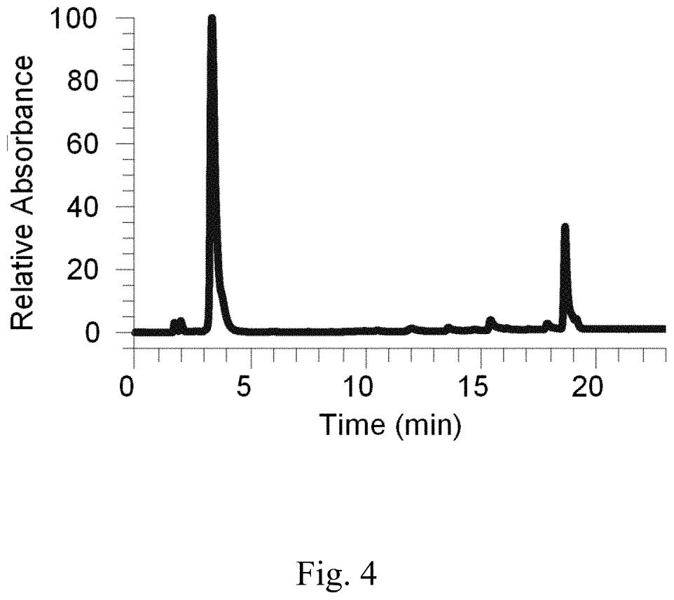

FIG. 4 was DtBP and DMT.

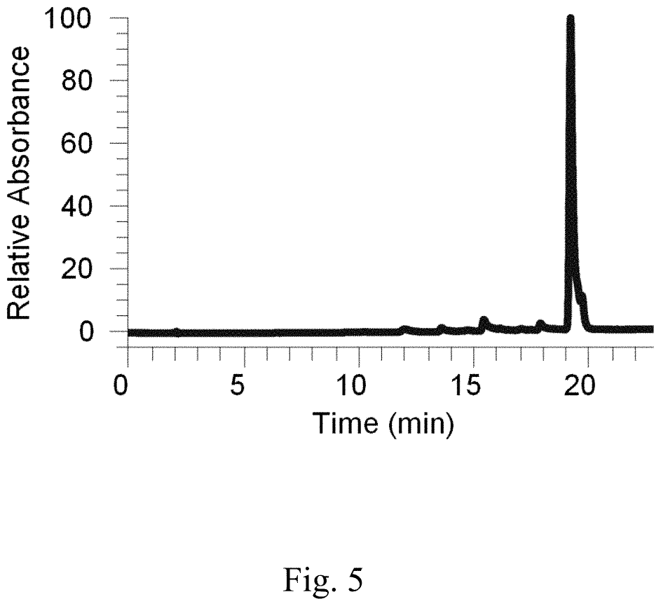

FIG. 5 was BHT, and

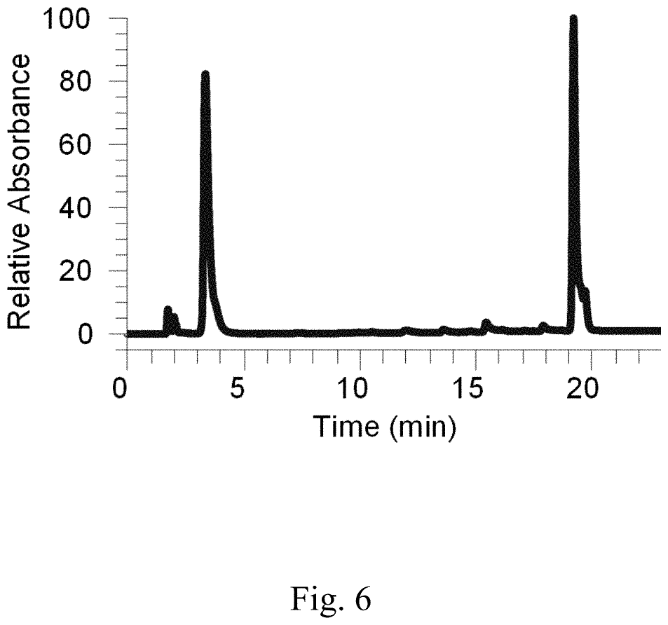

FIG. 6 was BHT and DMT.

The following is a detailed description of the invention.

As used herein, the following terms have the designated definitions, unless the context clearly indicates otherwise.

As used herein, “resin” is synonymous with “polymer.” “Polymer,” as used herein, refers to relatively large molecules made up of the reaction products of smaller chemical repeat units. Polymers may have structures that are linear, branched, star shaped, looped, hyperbranched, crosslinked, or a combination thereof; polymers may have a single type of repeat unit (“homopolymers”) or they may have more than one type of repeat unit (“copolymers”). Copolymers may have the various types of repeat units arranged randomly, in sequence, in blocks, in other arrangements, or in any mixture or combination thereof. A polymer has weight-average molecular weight of 2,000 or higher. A polymer that is sufficiently crosslinked that is insoluble in all solvents is considered to have infinite molecular weight.

Vinyl monomers have the structure (II)

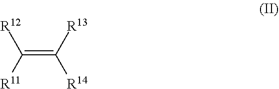

where each of R¹¹, R¹², R¹³, and R¹⁴ is, independently, a hydrogen, a halogen, an aliphatic group (such as, for example, an alkyl group), a substituted aliphatic group, an aryl group, a substituted aryl group, another substituted or unsubstituted organic group, or any combination thereof. Vinyl monomers are capable of free radical polymerization to form polymers. Some vinyl monomers have one or more polymerizable carbon-carbon double bonds incorporated into one or more of R¹¹, R¹², R¹³, and R¹⁴, and such vinyl monomers are known herein as multifunctional vinyl monomers. Vinyl monomers with exactly one polymerizable carbon-carbon double bond are known herein as monofunctional vinyl monomers.

Styrenic monomers are vinyl monomers in which each of R¹¹, R¹², and R¹³ is hydrogen or an unsubstituted alkyl and R¹⁴ contains one or more substituted or unsubstituted aromatic ring.

Acrylic monomers are vinyl monomers in which each of R¹¹ and R¹² is hydrogen; R¹³ is either hydrogen or methyl; and R¹⁴ is a carboxyl group, a carboxylate ester group (in which the ester group is a substituted or unsubstituted alkyl group), an amide group (in which the nitrogen atom is bonded to zero, one, or two substituted or unsubstituted alkyl groups).

A reaction among monomers to form one or more polymers is referred to herein as a polymerization process. The residue of a monomer after a polymerization process has taken place is known herein as a polymerized unit of that monomer.

Polymer beads are individual particles, each containing 50% or more by weight of polymer. Beads are in the solid state at 23° C. Beads have volume-average diameter of 10 μm or greater. If a particle is not spherical, the diameter of the particle is taken herein to be the diameter of an imaginary sphere that has the same volume as the particle.

As used herein, alkyl groups and alkenyl groups may be linear, branched, cyclic, or a combination thereof.

As used herein, a chemical group is said herein to be “substituted” if a substituent (that is, an atom or chemical group) is attached. Suitable substituents include, for example, alkyl groups, alkynyl groups, aryl groups, halogen atoms, nitrogen-containing groups including amine groups (including mono- and dialkylamine groups), oxygen-containing groups (including carboxyl groups and oxyalkyl groups), sulfur-containing groups (including sulfonic acid groups), nitrile groups, and combinations thereof.

As used herein, a heterocyclic aromatic group is a group that contains an aromatic ring in which one or more member of the aromatic ring is a heteroatom. A heteroatom is an atom other than carbon and hydrogen.

A collection of particles is characterized by the volume-based distribution of diameters. The parameter D60 denotes the value of a diameter that has the property that exactly 60% of the collection of the particles, by volume, have diameter less than or equal to D60. The parameter D10 denotes the value of a diameter that has the property that exactly 10% of the collection of the particles, by volume, have diameter less than or equal to D10. The parameter “uniformity coefficient” (abbreviated “UC”) is UC=D60/D10.

A collection of particles is also characterized by the harmonic mean diameter (HMD), which is defined as

$$HMD = \frac{N}{{\sum }_{i = 1}^{N} ( \frac{1}{{d}_{i}} )}$$

Resin beads are said herein to have a sulfonic acid group if the sulfonic acid group is bonded to a carbon atom of the polymer. The sulfonic acid group may be in the hydrogen form or in an anionic form with an associated cation.

Resin beads may also be classified according to the porosity of the beads, which is measured on dried resin using the Brunauer-Emmett-Teller (BET) method using nitrogen gas. Macroreticular (“MR”) resin beads have number-average pore diameter of 50 nm to 500 nm. Gel resin beads have much smaller pores than MR resin beads. The number-average pore diameter of gel resin beads is often too small to measure properly with the BET method. The number-average pore diameter of gel resin beads is considered to be less than 20 nm.

Ratios are characterized herein as follows. For example, when a ratio is said to be 3:1 or greater, that ratio may be 3:1 or 5:1 or 100:1 but may not be 2:1. To state this in a general way, when a ratio is said herein to be X:1 or greater, it is meant that the ratio is Y:1, where Y is greater than or equal to X. Similarly, for example, when a ratio is said to be 15:1 or less, that ratio may be 15:1 or 10:1 or 0.1:1 but may not be 20:1. To state this in a general way, when a ratio is said herein to be W:1 or less, it is meant that the ratio is Z:1, where Z is less than or equal to W

The present invention is a composition that contains a collection of resin beads. Preferred resins contain polymerized units of one or more vinyl monomer. Preferably the amount of polymerized units of vinyl monomer in the resin is, by weight based on the weight of the resin, 95% or more; more preferably 99% or more.

Preferred resins contain polymerized units of one or more styrenic monomer. Preferred styrenic monomers are styrene, alkyl-substituted styrenes, divinylbenzene, and mixtures thereof; more preferred are styrene, divinylbenzene, and mixtures thereof. Preferably the amount of polymerized units of styrenic monomer in the resin is, by weight based on the weight of the resin, 50% or more; more preferably 75% or more; more preferably 85% or more; more preferably 95% or more; more preferably 99% or more.

Preferred resin beads are gel resin beads.

Preferably, the collection of resin beads has harmonic mean diameter of 100 μm or larger; more preferably 200 μm or larger; more preferably 400 μm or larger; more preferably 600 μm or larger. Preferably, the collection of resin beads has uniformity coefficient of 1.8 or smaller; more preferably 1.5 or smaller; 1.3 or smaller; more preferably 1.2 or smaller; more preferably 1.15 or smaller.

Preferably, the amount of polymerized units of multifunctional vinyl monomer is, by weight based on the weight of the resin, 0.5% or more; more preferably 1% or more; more preferably 1.5% or more. Preferably, the amount of polymerized units of multifunctional vinyl monomer is, by weight based on the weight of the resin, 15% or less; more preferably 10% or less; more preferably 8% or less; more preferably 6% or less. The preferred multifunctional vinyl monomer is divinylbenzene.

The resin may be characterized by the amount of sulfonic acid groups attached to the resin. Sulfonic acid groups are considered herein to contribute to this “amount” if they are attached to the resin and if the SO₃ group is intact. Thus, sulfonic acid groups contribute to this “amount” whether they are in hydrogenated form, in ionic form, ester form, in a complex with another chemical group, or some other form, as long as they are attached to the resin and the SO₃ groups are intact.

Preferably, the mole ratio of sulfonic acid groups attached to the resin to polymerized units of all monomers is 0.1:1 or greater; more preferably 0.2:1 or greater; more preferably 0.5:1 or greater; more preferably 0.75:1 or greater. Preferably, the mole ratio of sulfonic acid groups attached to the resin to polymerized units of all monomers is 2:1 or lower; more preferably 1.5:1 or lower; more preferably 1.3:1 or lower.

Preferably, the sulfonic acid groups are present in the resin at 0.3 mole per liter of resin (mol/L) or more; more preferably 0.4 mol/L or more; more preferably 0.5 mol/L or more; more preferably 0.6 mol/L or more. Preferably, the sulfonic acid groups are present in the resin at 4 mol/L or less; more preferably 3 mol/L or less; more preferably 2 mol/L or less.

The composition of the present invention contains one or more promoter. The promoter contains an amine group. The amine group is preferably selected from primary amines, secondary amines, tertiary amines, and heterocyclic aromatic groups in which a heteroatom in the cycle is a nitrogen; more preferably the amine group is selected from primary amines and heterocyclic aromatic groups in which a heteroatom in the cycle is a nitrogen; more preferably the amine group is a primary amine.

The promoter additionally contains a thiol group. Preferably the promoter contains no heteroatom other than the nitrogen atom in the amine group and the sulfur atom in the thiol group.

Preferred promoters are selected from structures (III) and (IV)

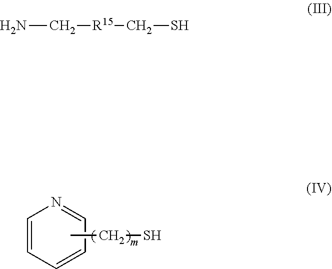

where R¹⁵ is either absent or is an unsubstituted alkyl group, and m is 1 to 10. Preferably, among structures (III), R¹⁵ is (CH₂)ₚ where p is 0 to 10; more preferably p is 0 to 5; more preferably p is 0 to 2; more preferably, p is 0. Preferably, among structures (IV), m is 1 to 3; more preferably 1. Among structures (IV), a preferred embodiment is 2-mercaptomethylpyridine. Structure (III) is preferred.

The promoter that has structure (III), where R′⁵ is absent, is cysteamine, also called 2-aminoethan-1-thiol. When 2,2-dimethylthiazolidine (“DMT”) is added to resin beads, it is considered herein to be equivalent to adding cysteamine to the resin beads. This equivalence arises because water is normally present, and an equilibrium chemical reaction is established, with a mixture of DMT with water on one side of the chemical reaction and a mixture of cysteamine with acetone on the other side.

Preferably, the amine group on the promoter molecule forms an ionic complex with the sulfonic acid group on the resin. That is, preferably, the hydrogen atom on an SO₃H group on the resin partially or fully transfers to the amine group on the promoter, and the promoter remains in proximity to the sulfonic acid group.

Preferably, the mole ratio of promoter to sulfonic acid groups is 0.1:1 or more; more preferably 0.12:1 or more. Preferably, the mole ratio of promoter to sulfonic acid groups is 0.45:1 or less; more preferably 0.35:1 or less.

The composition of the present invention contains an antioxidant that has structure (I):

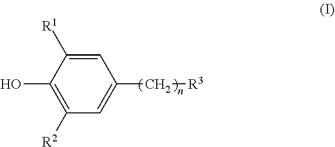

where each of R¹ and R², and R³ is hydrogen or a substituted or unsubstituted alkyl or alkenyl group; where n is 0 to 20, with the proviso that when R³ contains one or more nitrogen atoms, n is not 1 or 2.

Preferably, each of R¹ and R² contains 3 or more carbon atoms, more preferably 4 or more. Preferably, each of R¹ and R² contains 12 or fewer carbon atoms; more preferably 8 or fewer; more preferably 6 or fewer; more preferably 4 or fewer. Preferably, each of R¹ and R² is an unsubstituted alkyl. Preferably, each of R¹ and R² is t-butyl.

Preferably R³ contains no nitrogen atom; more preferably, R³ contains no heteroatom. Preferably R³ is hydrogen or an unsubstituted alkyl, more preferably hydrogen or methyl. Preferably n is 15 or less; more preferably 10 or less; more preferably 5 or less; more preferably 3 or less; more preferably 1 or less; more preferably zero.

Preferably the amount of antioxidant is such that the mole ratio of antioxidant to sulfonic acid groups is 0.0002:1 or greater; more preferably 0.0005:1 or greater; more preferably 0.001:1 or greater. Preferably the amount of antioxidant is such that the mole ratio of antioxidant to sulfonic acid groups is 0.1:1 or lower; more preferably 0.05:1 or lower; more preferably 0.01:1 or lower.

The composition of the present invention may be made by any method. Preferably, the collection of resin beads is made by aqueous suspension polymerization of vinyl monomers, preferably including styrene and divinylbenzene. Preferably, after the polymerization is complete, the resin is subjected to one or more chemical reactions that attach sulfonic acid groups to the resin. Regardless of the method used for making the resin beads that have sulfonic acid groups, preferably the resin beads that have sulfonic acid groups are mixed with a promoter. Preferably the promoter forms an ionic complex with the sulfonic acid groups on the resin. Then, preferably, the collection of resin beads is washed with water, leaving some or all of the promoter attached to the resin beads, and the resin beads are preferably then dried, for example by heating to above 30° C. under a pressure less than 1 atmosphere. The result of mixing promoter with the collection of resin beads is herein called “promoted resin beads.”

Preferably, promoted resin beads are then mixed with antioxidant. When the antioxidant is not soluble in water, the antioxidant may be dissolved in an organic solvent, acetone for example, to form a solution. The solution may be mixed with the promoted resin beads, and then the organic solvent may be evaporated.

While the present invention is not limited to any specific mechanism, it is contemplated that the degradation of antioxidants that were previously thought to be effective proceeds as follows. As an illustrative example, ETHANOX™ 703 (Albemarle Corporation), which has structure (V) below, may be considered. It has been discovered that ETHANOX™ 703 can degrade into the structure (VI) shown below. The carbon-carbon double bond external to the ring in structure (VI) can then react with a thiol group on a promoter to form structure (VII) or isomers thereof. The formation of structure (VII) ties up the thiol group and renders the promoter ineffective. The chemical reactions involved are shown schematically as follows, using cysteamine as an example of a promoter.

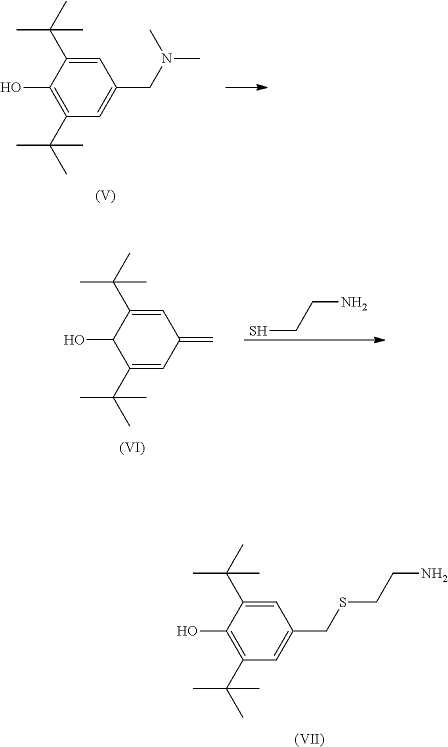

The following are examples of the present invention.

All operations were performed at room temperature (approximately 23° C.) unless otherwise specified.

### EXAMPLE 1: LC/UV/MS TESTING OF SOLUTIONS

Liquid Chromatograph with ultraviolet detector (LC/UV) conditions were as follows. ACCUCORE™ AQ C18 column (ThermoFisher Scientific) with a dimension of 150×4.6 mm, and a 5 μm particle; column temperature was held at 30° C. The mobile phase A was water with 15 mM ammonium formate and 15 mM formic acid, and B was ACN with 0.1% formic acid. The following gradient was employed: 5% B (3 min) to 80% B within 15 min (hold for 5 min); flow rate was set at 1 mL/min. A diode array UV detector was used with scan range of 210 nm-600 nm, and the capacity to record data at various individual wavelengths. Injection volume was 1 uL for all samples.

Heated electrospray ionization (HESI) conditions were as follows: Spray voltage (+): 3500 V; Capillary Temperature: 320° C.; Sheath Gas: 35; Auxiliary gas: 10; Sweep gas: 3; Probe Heater Temperature: 110° C.; S-Lens RF Level: 50 V.

Mass spectrometry (MS) conditions were as follows. Full MS/dd-MS/MS mode. In-source CID: 5 eV; Default charge state: 2; Full MS resolution: 35,000; AGC target: 5e6; Maximum IT: 100 ms; Scan range: 70-1050 m/z; profile data type; dd-MS/MS resolution: 17,500; AGC target: 5e6, Maximum IT: 100 ms; Loop count: 3; MSX count: 1; TopN: 3; Isolation window: 4.0 m/z; NCE: 40 V, Stepped NCE: 50%.

Three antioxidants were used: ETHANOX′ 703 (comparative), as described above, BHT, and DtBP:

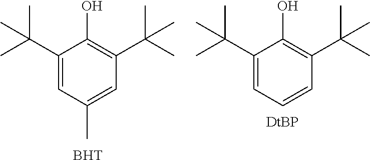

The promoter used was 2,2-dimethylthiazolidine (“DMT”), which is known to convert to cysteamine when in contact with water.

Stock solutions were prepared in acetonitrile (ACN) as follows:

| Stock Solution | Solute | Concentration |
|---|---|---|
| SS-DMT | DMT | 7 mg/mL |
| SS-Eth | ETHANOX ™ 703 | 8 mg/mL |
| SS-DtBP | DtBP | 10 mg/mL |
| SS-BHT | BHT | 10 mg/mL |

Test Mixtures were prepared as follows:

| Test Mixture | SS-DMT | SS-Eth | SS-DtBP | SS-BHT |
|---|---|---|---|---|
| Eth-only | | 100 μL | | |
| Eth/DMT | 100 μL | 100 μL | | |
| DtBP-only | | | 100 μL | |
| DtBP/DMT | 100 μL | | 100 μL | |
| BHT-only | | | | 100 μL |
| BHT/DMT | 100 μL | | | 100 μL |

Test mixtures were stored for 3 days at room temperature (approximately 23° C.) and then diluted to 1 mL with ACN/water (50/50 by volume) for LC/UV/MS analysis.

The results for the Eth-only test mixture are shown in FIG. 1, which shows the relative intensity of the UV detector, using the 210-600 nm array. The peak at 14.3 minutes was identified by the MS analysis as the compound ETHANOX™ 703 (structure (V)).

The results for the Eth/DMT test mixture are shown in FIG. 2, which shows the relative intensity of the UV detector, using the UV detection array at 265-285 nm. The peaks below 5 minutes were shown by MS analysis to be degradation products of DMT, including cysteamine. The peak at 14.8 minutes was not present in the Eth-only test, and this peak was shown by MS analysis to be structure (VII). This demonstrates that, in the solution with both ETHANOX™ 703 and DMT, the two solutes react with each other. Further, the area of the peak at 14.3 minutes (ETHANOX™ 703) is smaller than the area of the corresponding peak in the Eth-only test. This verifies that the concentration of ETHANOX™ 703 is diminished in the presence of DMT.

FIGS. 3 and 4 compare DtBP-only with DtBP/DMT. The data shown correspond to a combination of a single wavelength in the UV detector of 275 nm. The peaks below 5 minutes were shown by MS analysis to be degradation products of DMT, including cysteamine. The peak at 18.6 minutes was identified by MS as DtBP itself. The peak areas for DtBP are the same in FIGS. 3 and 4, which shows that the concentration of DtBP did not decrease due to contact with DMT. Also, there are no peaks in FIG. 4 that corresponds to any reaction product between DtBP and DMT.

FIGS. 5 and 6 compare BHT-only with BHT/DMT. The data shown correspond to a single wavelength in the UV detector of 275 nm. The peaks below 5 minutes were shown by MS analysis to be degradation products of DMT, including cysteamine. The peak at 19.2 minutes was identified by MS as BHT itself. The peak areas for BHT are the same in FIGS. 5 and 6, which shows that the concentration of BHT did not decrease due to contact with DMT. Also, there are no peaks in FIG. 6 that corresponds to any reaction product between BHT and DMT.

### EXAMPLE 2: MIXTURE OF RESIN BEADS, PROMOTER, AND ANTIOXIDANT

The resin (“Resin-1”) was AMBERLYST™ 131 (The Dow Chemical Company), used as supplied, in hydrogen form. Resin-1 is a gel resin with sulfonic acid groups, harmonic mean diameter of 700-800 μm, acid group concentration of >1.35 mol/L, and uniformity coefficient of less than 1.15.

The promoter was DMT. The antioxidants were ETHANOX™ 703 (comparative) and BHT.

A stock solution was prepared of 0.085 g ETHANOX™ 703 in 20 g of solution with acetone as solvent. A stock solution was prepared of 0.071 g BHT in 20 g of solution with acetone as solvent.

The following procedure was used.

Resin-1 was hot washed as follows. A vertical chromatography column equipped with circulated water jacket was used, with water circulating at 90° C. 120 mL of Resin-1 was loaded into the column. Then a fill/hold/drain cycle was performed: the column was filled with 1.2 bed volumes (BV) water and held for 40 minutes, and then the water was drained. Then the fill/hold/drain cycle was performed two more times. Then the resin was rinsed with 5 BV of deionized water at 2 BV/hour.

Then Resin-1 was cold washed as follows. The hot water was drained from the recirculating jacket, and deionized water at approximately 23° C. was flowed through the column at 4 BV/hr.

Then DMT was loaded onto the resin beads as follows. The sample of Resin-1 was placed into a 250 mL three-neck flask equipped with a stirrer, along with enough water to make a slurry. 4.75 g of DMT was dissolved into 30 mL of deionized water, which was then added dropwise into the slurry under stirring, and stirring continued for 1 hour. The stirring was stopped, and liquid was removed by siphon. The Resin-1 was transferred back to the column, and the resin was rinsed with 5 BV of deionized water approximately 23° C. at 2 BV/hr.

Then antioxidant was loaded onto Resin-1 as follows. The resin was dried at 40° C. in a vacuum oven. 20 g of the antioxidant stock solution (described above) was added, and the mixture stirred for 30 minutes. Then the acetone was removed by evaporation in a vacuum oven at approximately 23° C.

The Resin-1, loaded with promoter and antioxidant as described above, was then put into a bottle, kept in an oven at 80° C. for 2 hours, then stored at approximately 23° C. for 7 days.

50 g of Resin-1 and 150 g of deionized water were shaken in a container for 20 minutes at approximately 23° C. Using a gravity funnel and filter paper, the bulk liquid was separated from the resin beads. The conductivity and the pH of the bulk liquid was measured using an Expanded Range Conductivity Meter #23226-523 (VWR International) and a pH meter.

It is considered that the exposure to 80° C. for two hours provides a test of the stability of the catalyst resin when exposed to long term and/or elevated-temperature storage.

Results were as follows:

| Antioxidant | pH | Conductivity |
|---|---|---|
| ETHANOX ™ 703 (Comparative) | 3.17 | 281.5 μS |
| BHT | 3.23 | 241.5 μS |

When a resin loaded with promoter and antioxidant is stored, it is normally observed that, as the resin, the promoter, and/or the antioxidant degrade, the pH falls and the conductivity rises. The above table shows that BHT preserves the composition, because the BHT sample had higher pH and lower conductivity.

1. A catalyst composition comprising
(a) a collection of resin beads having sulfonic acid functional groups,
(b) a promoter having a thiol group and an amine group, and
(c) an antioxidant having the structure (I) 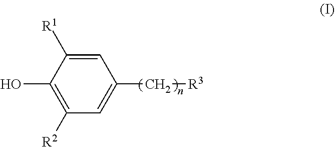
wherein each of R¹ and R², and R³ is hydrogen or a substituted or unsubstituted alkyl or alkenyl group
wherein n is 0 to 20, with the proviso that when R³ contains one or more nitrogen atoms, n is not 1 or 2.

2. The catalyst composition of claim 1, wherein each or R¹ and R² is independently an unsubstituted alkyl group having 2 to 20 carbon atoms.

3. The catalyst composition of claim 1, wherein R³ is hydrogen or an unsubstituted alkyl group.

4. The catalyst composition of claim 1, wherein R³ is hydrogen, and n is zero.

5. The catalyst composition of claim 1, wherein R³ is methyl, and n is zero.

6. The catalyst composition of claim 1, wherein the resin comprises polymerized units of one or more styrenic monomers.

7. The catalyst composition of claim 1, wherein the antioxidant comprises 2,2-dimethylthiazolidine, cysteamine, or a mixture thereof.
